(19) United States
(12) Patent Application Publication
(10) Pub. No.: US 2023/0417958 A1
(43) Pub. Date: Dec. 28, 2023

(54) VEHICLE DISPLAY DEVICE ANTI-GLARE COVER LENS AND VEHICLE DISPLAY APPARATUS

(71) Applicant: Zhejiang Prism Holographic Technology Co., Ltd., Zhejiang (CN)

(72) Inventors: Jianwen REN, Zhejiang (CN); Xianchu PENG, Zhejiang (CN)

(73) Assignee: Zhejiang Prism Holographic Technology Co., Ltd., Zhejiang (CN)

(21) Appl. No.: 17/849,710

(22) Filed: Jun. 27, 2022

(51) Int. Cl. G02B 5/00; B60R 11/02

(52) U.S. Cl. CPC G02B 5/003; B60R 11/0229

(57) ABSTRACT

Disclosed is a vehicle display device anti-glare cover lens, including: a transparent substrate configured to allow transmission of light emitted from a light source; and a plurality of anti-glare baffles, the anti-glare baffles being fixed on the substrate and configured to block sunlight from causing glare, wherein the spacing between bottom portions of adjacent anti-glaring baffles is less than the spacing between top portions of the adjacent anti-glaring baffles. Further disclosed is a vehicle display apparatus which employs the vehicle display device anti-glare cover lens.

### TECHNICAL FIELD

The disclosure relates to a vehicle display device anti-glare cover lens and a vehicle display apparatus.

### BACKGROUND

Vehicle display devices are increasingly applied. The vehicle display device is usually mounted at the dashboard. To avoid adverse effects from sunlight or ambient light which, when entering the vehicle, causes glare affecting the driver's normal field of view and potentially leading to safety hazards, such display devices generally pose a higher standard on anti-glare performance.

Conventional manner of glare elimination is to use a curved surface with a specific radian to reflect the sunlight. However, such an approach has a relatively large space occupation, e.g., over 20 mm in the vertical direction, which adds deployment complexity given the limited space inside a vehicle.

### SUMMARY

A vehicle display device anti-glare cover lens and a vehicle display apparatus are provided, which may effectively solve the problem that conventional vehicle display apparatuses are susceptible to incur glare when being irradiated by sunlight.

A vehicle display device anti-glare cover lens comprises:
a transparent substrate configured to allow transmission of light emitted from a light source; and
a plurality of anti-glare baffles, the anti-glare baffles being fixed on the substrate and configured to block sunlight from causing glare, wherein the spacing between bottom portions of adjacent anti-glaring baffles is less than the spacing between top portions of the adjacent anti-glaring baffles.

Preferably, the anti-glare baffle comprises a sun-facing side and a back side, wherein the angle formed between the back side and a horizontal plane in an incident direction of the sunlight is denoted as α, and the angle formed between the sun-facing side and the horizontal plane in the incident direction of the sunlight is denoted as β, both α and β being acute, and α≠β. All of the anti-glare baffles are inclined towards one direction, which facilitates control of glare and facilitates the anti-glare baffles to play their roles; moreover, controlling the angles of the sun-facing side and back side ensures a smaller spacing between the bottom portions and a larger opening between the top portions of adjacent anti-glare baffles, such that the transmitted light may have a better incident angle.

Preferably, all of the anti-glare baffles are arranged at even intervals. The even interval arrangement facilitates imaging with uniform brightness after the light emitted from the light source passes between the anti-glare baffles.

Preferably, given the angle α formed between the back side and the horizontal plane in the incident direction of the sunlight, the vertical height h of the back side, and the projection length L of the back side on the horizontal plane, L≤3*h/tan α. By controlling the proportional relationship between α, h, and L, the sunlight may be effectively blocked to avoid glare and meanwhile the anti-glare baffles may maintain a steady angle.

Preferably, the longitudinal cross section of the anti-glare baffles is of a trapezoid shape or a triangular shape. Such shapes are easy to manufacture and may better satisfy structural requirements of the anti-glare baffles, which facilitate reduction of manufacturing costs.

Preferably, the spacing between the bottom portions of adjacent anti-glare baffles ranges from 0.001 to 3 mm. An overly small spacing would affect imaging of the light from the light source, causing blurred images; while an overly large spacing would increase the height of anti-glare baffles, causing increase of the overall height of the cover lens, unfavorable to install the vehicle display device.

Preferably, a proportion between the spacing between the bottom portions of the adjacent anti-glare baffles and the length of the bottom portion of each individual anti-glare baffle ranges from 1:10 to 10:1. An overly small proportion would cause shrinkage of the light transmission area of the substrate and overly dark images, unfavorable to image; while an overly high proportion would require increase of the height of anti-glare baffles, causing installation difficulty.

Preferably, the anti-glare baffle comprises a sun-facing side and a back side, wherein a light adsorption layer or a diffuse reflection layer is applied on the sun-facing side and/or back side. Application of the light adsorption layer or the diffuse reflection layer effectively avoids occurrence of glare.

A vehicle display apparatus is provided, which employs the vehicle display device anti-glare cover lens.

Compared with conventional technologies, the disclosure offers the following benefits: the transparent substrate enables the image generated from the device below to be projected out, while the anti-glare baffles serve to block direct sunlight to thereby eliminate glare; meanwhile, due to arrangement of a plurality of anti-glare baffles, the overall height of the anti-glare baffles may be reduced, thereby effectively reducing the overall height of the cover lens, reducing the installation space, and lowering the installation difficulty; by setting the spacing between the bottom portions of adjacent anti-glare baffles to be smaller than the spacing between the top portions of the adjacent anti-glare baffles, a gradually enlarged passage is formed between two adjacent anti-glare baffles, which facilitates the light emitted from the light source of the vehicle display device to pass out to produce an image and facilitates improvement of imaging definiteness and imaging brightness. In addition, the reduced height of the anti-glare baffles facilitates lowering of the gravity center of individual anti-glare baffles, such that the anti-glare baffles are fixed on the substrate more securely. A vehicle display apparatus employing the vehicle display device anti-glare cover lens may better prevent glare caused by sunlight.

### BRIEF DESCRIPTION OF THE DRAWINGS

FIG. 1 is a structural schematic diagram of a first example of a vehicle display device anti-glare cover lens according to the disclosure;

FIG. 2 is a structural schematic diagram of a second example of the vehicle display device anti-glare cover lens according to the disclosure.

### DETAILED DESCRIPTION

Hereinafter, embodiments of the disclosure will be described in detail. Examples of the embodiments are shown in the drawings. The examples described below with reference to the accompanying drawings are intended to explain the disclosure, which shall not be construed as limiting the disclosure.

In the description of the disclosure, it needs to be understood that the orientational or positional relationships indicated by the terms “center,” “longitudinal,” “transverse,” “length,” “width,” “thickness”, “upper,” “lower,” “front,” “rear,” “left,” “right,” “vertical,” “horizontal,” “top,” “bottom,” “inner,” and “outer,” etc. are orientational and positional relationships based on the drawings, which are intended only for facilitating or simplifying description of the disclosure, not for indicating or implying that the devices or elements have to possess those specific orientations and have to be configured and operated with such specific orientations; therefore, they should not be understood as limitations to the disclosure.

In the disclosure, unless otherwise explicitly provided and limited, the terms such as “mount,” “attach,” “connection,” and “fix” should be understood broadly, which, for example, may refer to a secured connection, a detachable connection, or an integral connection; which may be a mechanical connection or an electrical connection; which may be a direct connection or an indirect connection via an intermediate medium; which may also be a communication between the insides of two elements or an interactive relationship between the two elements, unless otherwise explicitly defined. To a person of normal skill in the art, specific meanings of the above terms in the disclosure may be understood based on specific situations.

### First Example

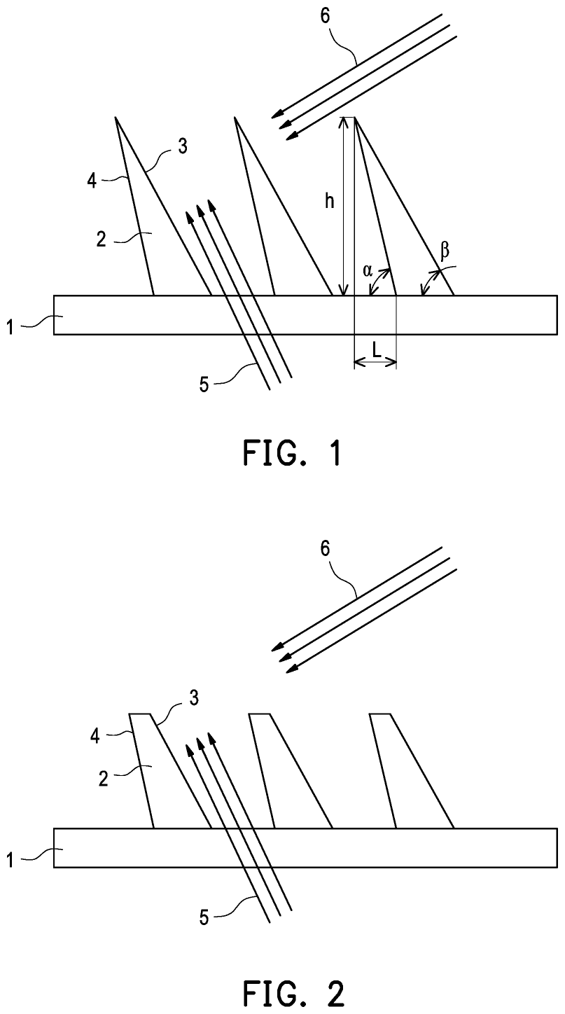

FIG. 1 illustrates a first example of a vehicle display device anti-glare cover lens according to the disclosure. The vehicle display device anti-glare cover lens comprises: a transparent substrate 1 configured to allow transmission of light 5 emitted from a light source; a plurality of anti-glare baffles 2, the anti-glare baffles 2 being fixed on the substrate 1 and configured to block sunlight 6 from causing glare, wherein a spacing between bottom portions of adjacent anti-glare baffles 2 is smaller than a spacing between top portions of the adjacent anti-glare baffles 2; in this example, the light 5 emitted from the light source exits upward from the lower portion of the substrate 1; the anti-glare baffles 2 are fixed on the upper surface of the substrate 1, such that the sunlight 6 above the substrate 1 directly falls on the anti-glare baffles 2, thereby avoiding glare occurrence.

To achieve a most stable shape of the anti-glare baffles 2 and meet the spacing requirement for adjacent anti-glare baffles 2, the anti-glare baffles 2 in this example have a triangular cross section, and a light adsorption layer or a diffuse reflection layer may be coated on the sun-facing side 3 and/or the back side 4 of the anti-glare baffles 2 so as to prevent the sunlight 6 from being reflected onto the windshield of the vehicle causing a shadow that would affect the user's vision.

The anti-glare baffles 2 are preferably arranged in a sequence so as to facilitate control of imaging uniformity after the light passes between the anti-glare baffles 2. In this example, the anti-glare baffles 2 are arranged in parallel at even intervals, and all of the anti-glare baffles 2 are inclined. Specifically, the anti-glare baffle 2 comprises a sun-facing side 3 and a back side 4, wherein the angle formed between the back side 4 and the horizontal plane in the incident direction of the sunlight 6 is denoted as α, and the angle formed between the sun-facing side 3 and the horizontal plane in the incident direction of the sunlight 6 is denoted as β, both α and β being acute and α≠β. Such inclined setting may reduce the height of the anti-glare baffles 2, thereby controlling the overall height of the cover lens, thereby facilitating installation in the vehicle.

The individual anti-glare baffles 2 may be further sized to shrink the overall height of all anti-glare baffles 2 while ensuring secure attachment of the anti-glare baffles 2. Given the angle α formed between the back side 4 and the horizontal plane in the incident direction of the sunlight 6, the vertical height h of the back side 4, and the projection length L of the back side 4 on the horizontal plane, L≤3*h/tan α. To ensure a good anti-glare effect and meanwhile not to affect imaging of the transmitted light emitted from the light source below the substrate 1, the spacing between the bottom portions of adjacent anti-glare baffles 2 is set in a range from 0.001 ˜3 mm, and the proportion between the spacing between the bottom portions of the adjacent anti-glare baffles 2 and the length of the bottom portion of each individual anti-glare baffle 2 ranges from 1:10 to 10:1. The specific value of the spacing between the bottom portions of adjacent anti-glare baffles 2 and the specific proportion between the spacing between the bottom portions of the adjacent anti-glare baffles 2 and the length of the bottom portion of each individual anti-glare baffle 2 may be selected dependent on the overall size of the anti-glare baffles 2 and the range of incident angle of the sunlight 6 to handle for anti-glare.

In this example, there is further provided a vehicle display apparatus that employs the vehicle display device anti-glare cover lens. It is only required to fix the cover lens on the original vehicle display device. It is preferable to install the vehicle display apparatus and the cover lens together. By aligning the vehicle display apparatus and the cover lens to adjust the displayed image, an optimal user experience may be achieved.

The vehicle display device anti-glare cover lens and the vehicle display apparatus in this example offer the following benefits: with arrangement of a plurality of anti-glare baffles 2, the overall height of the cover lens is notably reduced compared with conventional anti-glare vehicle display apparatuses, such that the vehicle display device anti-glare cover lens in this example is convenient for installation in the limited space in the vehicle; the reduced overall height would not protrude too much from the vehicle's dashboard and thus would not create a sense of in harmony; in addition, since the spacing between bottom portions of adjacent anti-glare baffles 2 is smaller than the spacing between top portions of the adjacent anti-glaring baffles 2, the impact of the anti-glare baffles 2 on the light exiting from the bottom of the substrate 1 is reduced, such that the light emitted from the bottom of the substrate 1 achieves a large diffuse angle, facilitating improvement of imaging brightness and imaging definiteness.

### Second Example

FIG. 2 illustrates a second example of the disclosure, which differs from the first example in that the anti-glare baffles 2 in this example have a trapezoid cross section, wherein two bevel edges of the trapezoid are located at the sun-facing side 3 and the back side 4, respectively; moreover, respective angles formed between each of the two bevel edges of the trapezoid and the horizontal plane in the incident direction of the sunlight 6 are acute. Compared with the anti-glare baffles 2 with a triangular cross section, the trapezoid configuration requires an increased height to achieve the same anti-glare effect; however, due to the planar top of trapezoid, it may effectively protect the user from being scratched upon touching.

What have been described above are only specific examples of the disclosure. However, the technical features of the disclosure are not limited thereto. Any alteration or modification made by those skilled in the art fall within the scope of the disclosure.

Which is claimed is:

1. A vehicle display device anti-glare cover lens, comprising:
a transparent substrate configured to allow transmission of a light emitted from a light source; and
a plurality of anti-glare baffles, the anti-glare baffles being fixed on the substrate and configured to block a sunlight from causing glare, wherein a spacing between bottom portions of adjacent anti-glare baffles is smaller than a spacing between top portions of the adjacent anti-glare baffles.

2. The vehicle display device anti-glare cover lens of claim 1, wherein each of the anti-glare baffles comprises a sun-facing side and a back side, wherein an angle formed between the back side and a horizontal plane in an incident direction of the sunlight is denoted as α, an angle formed between the sun-facing side and the horizontal plane in the incident direction of the sunlight is denoted as β, the α and β being both acute, and α≠β.

3. The vehicle display device anti-glare cover lens of claim 1, wherein all of the anti-glare baffles are arranged at even intervals.

4. The vehicle display device anti-glare cover lens of claim 2, wherein all of the anti-glare baffles are arranged at even intervals.

5. The vehicle display device anti-glare cover lens of claim 2, wherein given a vertical height h of the back side, and a projection length L of the back side on the horizontal plane, L≤3*h/tan α.

6. The vehicle display device anti-glare cover lens of claim 1, wherein a lengthwise section of the anti-glare baffle has a trapezoid or triangular shape.

7. The vehicle display device anti-glare cover lens of claim 1, wherein the spacing between bottom portions of adjacent anti-glare baffles ranges from 0.001 to 3 mm.

8. The vehicle display device anti-glare cover lens of claim 1, wherein a proportion between the spacing between the bottom portions of adjacent anti-glare baffles and a length of a bottom portion of each individual anti-glare baffle ranges from 1:10 to 10:1.

9. The vehicle display device anti-glare cover lens of claim 1, wherein each of the anti-glare baffle comprises a sun-facing side and a back side, a light adsorption layer or a diffuse reflection layer being applied to the sun-facing side and/or the back side.

10. A vehicle display apparatus, wherein the vehicle display apparatus employs the vehicle display device anti-glare cover lens according to claim 1.

11. A vehicle display apparatus, wherein the vehicle display apparatus employs the vehicle display device anti-glare cover lens according to claim 2.

12. A vehicle display apparatus, wherein the vehicle display apparatus employs the vehicle display device anti-glare cover lens according to claim 3.

13. A vehicle display apparatus, wherein the vehicle display apparatus employs the vehicle display device anti-glare cover lens according to claim 4.

14. A vehicle display apparatus, wherein the vehicle display apparatus employs the vehicle display device anti-glare cover lens according to claim 5.

15. A vehicle display apparatus, wherein the vehicle display apparatus employs the vehicle display device anti-glare cover lens according to claim 6.

16. A vehicle display apparatus, wherein the vehicle display apparatus employs the vehicle display device anti-glare cover lens according to claim 7.

17. A vehicle display apparatus, wherein the vehicle display apparatus employs the vehicle display device anti-glare cover lens according to claim 8.

18. A vehicle display apparatus, wherein the vehicle display apparatus employs the vehicle display device anti-glare cover lens according to claim 9.
